(19) United States
(12) Patent Application Publication
(10) Pub. No.: US 2014/0327905 A1
(43) Pub. Date: Nov. 6, 2014

(54) METHOD FOR DETECTING DEVIATION OF OPTIAL AXIS OF LENS AND METHOD FOR POSITIONING LENS TO LIGHT SOURCE

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 13/966,254

(22) Filed: Aug. 13, 2013

(30) Foreign Application Priority Data
May 2, 2013 (TW) 102115679

(51) Int. Cl. G01M 11/02

(52) U.S. Cl. CPC G01M 11/0221
USPC 356/127

(57) ABSTRACT

A method for detecting deviation of an optical axis of a lens is disclosed. Firstly, a lens is provided. The lens includes a light incident face and multiple legs surrounding the light incident face. A camera is used to capture images of the incident face and the legs. Two circles are then depicted according to the images. Two centers of the two circles are determined to obtain a deviation distance between the two centers.

### BACKGROUND

1. Technical Field

The disclosure generally relates to methods, and more particularly, to a method for detecting a deviation of an optical axis relative to a positioning structure of a lens, and a method for positioning the lens to a light source.

2. Description of Related Art

Nowadays LEDs (light emitting diodes) are applied widely in various applications for illumination. The LED is generally used with a lens to adjust light distribution thereof. The lens is mounted on a base of the LED to cover the LED so that light emitted from the LED can pass through and be adjusted by the lens to thereby obtain the required light distribution.

The lens may form a plurality of legs on a bottom face thereof, and the base may define a plurality of holes in a top face thereof. The legs of the lens are inserted into the holes of the base to position the lens on the base. Generally, the LED should be located at a center of the holes, and the optical axis of the lens should be located at a center of a geometry structure defined by the legs. Therefore, when the legs are inserted into the holes, the optical axis of the lens can be aligned with the LED to obtain the required light distribution. However, due to technical limitation, the optical axis of the lens may not be coincident with the center of the geometry structure defined by the legs of the lens. In other words, an optical center of the lens may be deviated from a mechanical center of the lens. Thus, when the lens is mounted on the base by inserting the legs into the holes, the optical axis of the lens is deviated from the LED. The deviation of the optical axis of the lens from the LED would cause the light distribution being unfavorable.

What is needed, therefore, is a method for detecting deviation of an optical axis of a lens and a method for positioning the lens to a light source which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 shows an LED unit with a lens ready for being detected by a method in accordance with an embodiment of the present disclosure.

FIG. 2 is an exploded view of the LED unit of FIG. 1.

FIG. 3 shows a cross section of the lens of FIG. 2.

FIG. 4 shows a first step of the method.

FIG. 5 shows a second step of the method.

### DETAILED DESCRIPTION

A method for detecting deviation of an optical axis O of a lens 10 is disclosed.

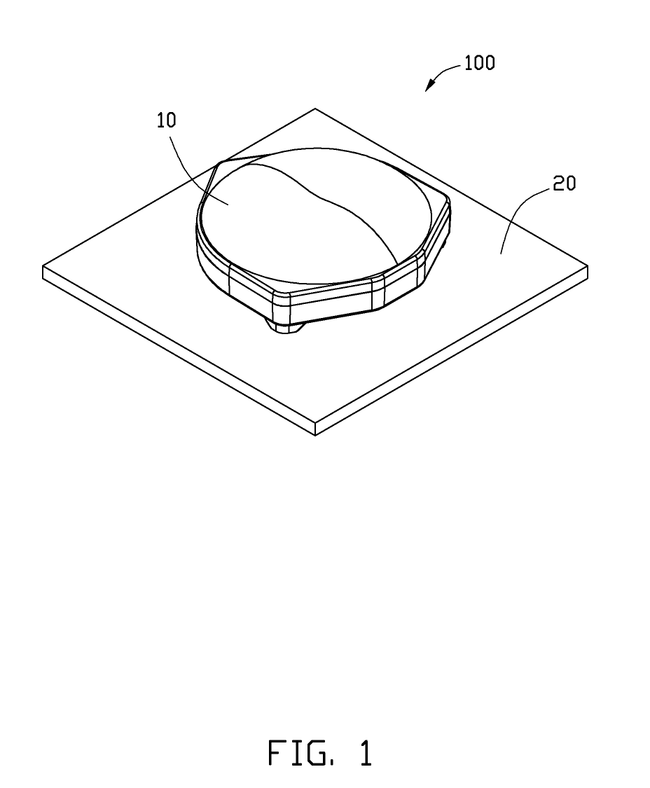

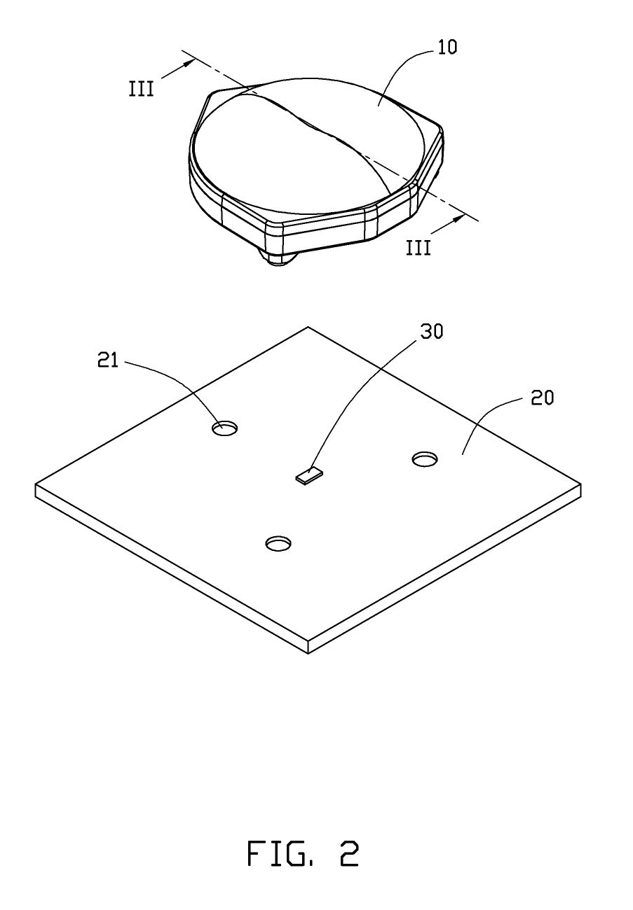

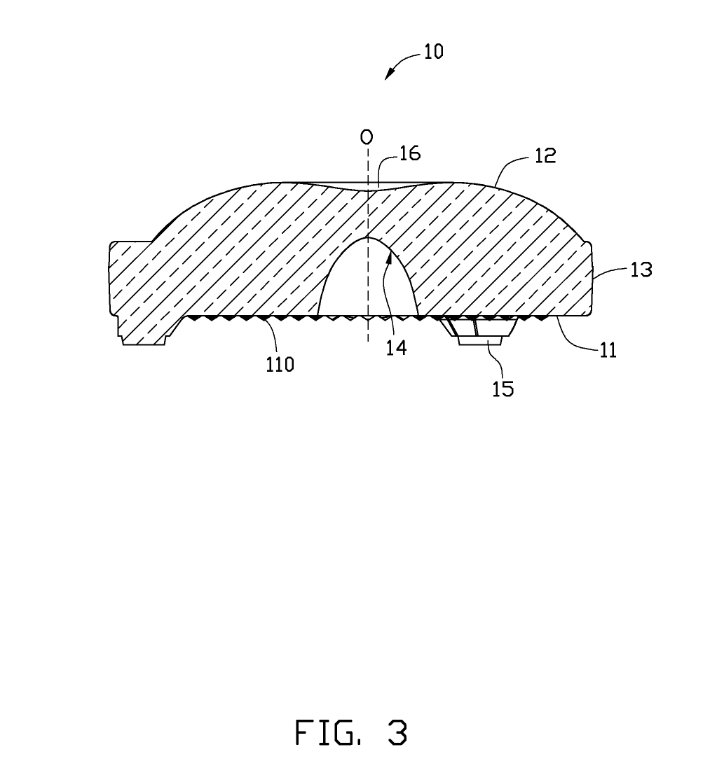

Referring to FIGS. 1-3, the lens 10 ready for being detected is disposed on a base 20 supporting an LED (light emitting diode) 30 thereon. The base 20 is rectangular and has three holes 21 defined in a top face thereof. The base 20 may be a circuit board for supplying power for the LED 30. Each hole 21 is circular and does not extend through a bottom face of the base 20. The three holes 21 cooperatively define a triangle or a circle. The LED 30 is located on a center of the triangle or circle defined by the three holes 21.

The lens 10 may be made of transparent material such as glass, epoxy, silicone or the like. The lens 10 includes a bottom face 11, a top face 12 opposite to the bottom face 11 and a lateral face 13 interconnecting the top face 12 and the bottom face 11. The bottom face 11 is flat and forms a plurality of protrusions 110 protruding downwardly. In this embodiment, each protrusion 110 has a shape similar to a pyramid. A central area of the bottom face 11 is concaved to form a light incident face 14. The light incident face 14 is curved and has a semi-elliptic cross section. The optical axis O extends through a center of the light incident face 14. The optical axis O is perpendicular to the bottom face 11. The top face 12 defines a depression 16 in a central area thereof corresponding to the light incident face 14.

The lens 10 further forms a positioning structure on the bottom face 11 thereof. In this embodiment, the position structure is three legs 15. Each leg 15 protrudes downwardly towards the base 20. The legs 15 surround the protrusions 110 and are located adjacent to an outer periphery of the lens 10. The legs 15 can be inserted into the holes 21 of the base 20 of mount the lens 10 on the base 20.

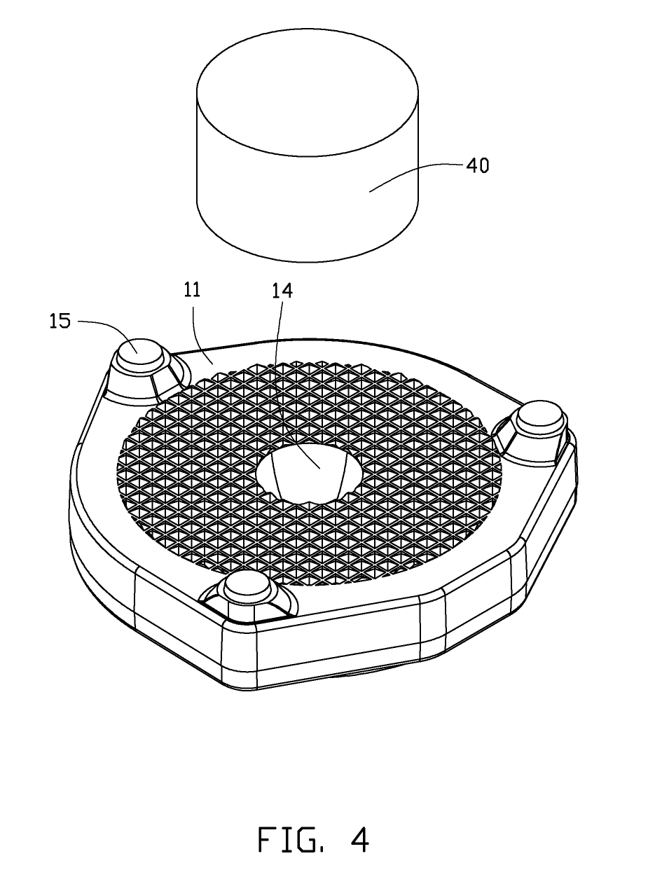

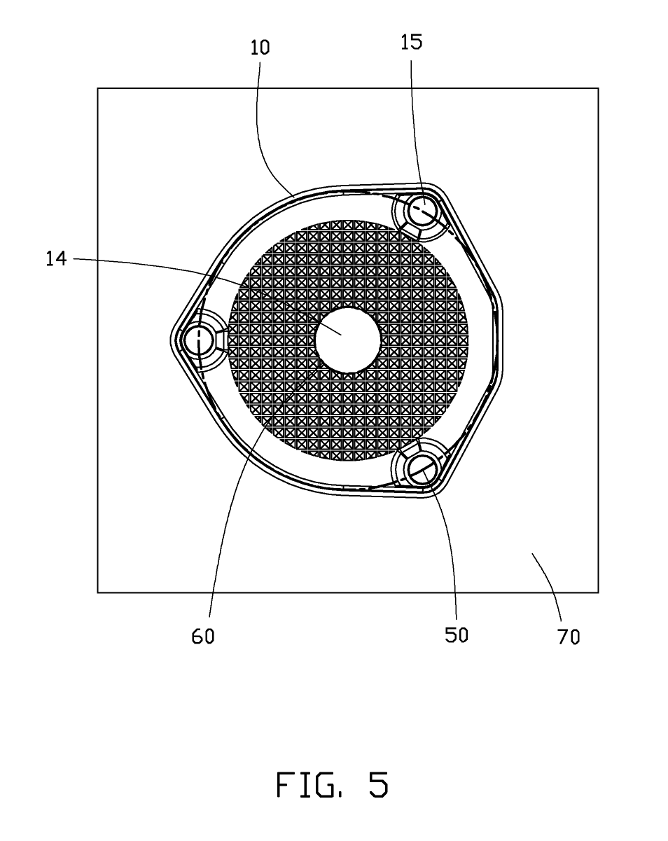

Also referring to FIGS. 4-5, a camera 40 is provided in order to detect whether the optical axis O is deviated from a center of a geometry structure cooperatively defined by the three legs 15. The lens 10 is firstly inverted as shown in FIG. 4 to make the bottom face 11 confronting the camera 40. The camera 40 captures images of the three legs 15 of the lens 10 to thereby depict a first circle 50 defined by the three legs 15. The camera 40 further captures an image of the light incident face 14 to thereby depict a second circle 60 defined by a periphery of the light incident face 14. A center of the second circle 60 is then compared with a center of the first circle 50 to detect whether the center of the second circle 60 is overlapped the center of the first circle 50. If the two centers are not overlapped, a deviation distance between the two centers are calculated and recorded. The deviation distance may be further shown on a display, whereby an operator can adjust a position of the LED 30 relative to the three holes 21 according to the deviation distance. Therefore, the LED 30 can be accurately aligned with the optical axis O of the lens 10.

Furthermore, a container 70 can be further provided before the lens 10 is captured by the camera 40. The container 70 defines a cavity to receive the lens 10, whereby the lens 10 can be held by the container 70 to facilitate capture of the lens 10 by the camera 40.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for detecting deviation of an optical axis of lens, comprising:
providing a lens comprising an optical face and a positioning structure outside the optical face;
detecting a center of the optical face and a center of a geometry structure defined by the positioning structure; and
comparing the center of the optical face with the center of the geometry structure defined by the positioning structure to obtain a deviation distance of the center of the optical face from the center of the position structure.

2. The method of claim 1, wherein the positioning structure comprises a plurality of legs surrounding the optical face.

3. The method of claim 2, wherein a camera is used to detect the center of the geometry structure of the legs, and the camera captures images of the legs and depicting a first circle according to the images of the legs, the center of the positioning structure being a center of the first circle.

4. The method of claim 3, wherein the optical face is a light incident face of the lens.

5. The method of claim 4, wherein the camera captures an image of a periphery of the light incident face and depicting a second circle according to the image of the light incident face, the center of the optical face being a center of the second circle.

6. The method of claim 1 further comprising disposing the lens in a container before detecting the center of the optical face and the center of the positioning structure.

7. The method of claim 4, wherein the lens comprises a bottom face defining the light incident face, the light incident face being concaved from a central area of the bottom face.

8. The method of claim 7, wherein the lens comprises a plurality of protrusions protruding downwardly from the bottom face.

9. The method of claim 8, wherein the protrusions surround the light incident face.

10. The method of claim 8, wherein each protrusion is a pyramid.

11. The method of claim 7, wherein the lens comprises a top face opposite to the bottom face, a depression being defined in a central area of the top face corresponding to the light incident face.

12. A method for positioning a lens to a light source, comprising:
providing a lens and a light source, the lens comprising an optical face and a first positioning structure, and the light source comprising a base and an emitter, the base comprising a second positioning structure;
capturing images of the optical face and the first positioning structure to determine a center of the optical face and a center of the first positioning structure;
comparing the center of the optical face with the center of the first positioning structure to obtain a deviation distance of the center of the optical face from the center of the first positioning structure;
adjusting a location of the emitter relative to the second positioning structure according to the deviation distance; and
matching the first positioning structure with the second positioning structure to mount the lens on the light source.

13. The method of claim 12, wherein the first positioning structure comprises a plurality of legs, and the second positioning structure comprises a plurality of holes.

14. The method of claim 13, wherein the legs surround the optical face, and the holes surround the emitter.

15. The method of claim 12, wherein the optical face is a light incident face of the lens.

16. The method of claim 15, wherein the lens comprises a bottom face defining the light incident face, a plurality of protrusions being formed on the bottom face and surrounding the light incident face.

17. The method of claim 12, wherein a camera is used to capture the images of the center of the optical face and the center of the first positioning structure.

18. The method of claim 17, wherein the camera depicts a first circle according to a periphery of the optical face after capturing the image of the optical face, and depicts a second circle according to a location of the first positioning structure after capturing the image of the first positioning structure.
